(19) United States
(12) Patent Application Publication
(10) Pub. No.: US 2006/0215036 A1
(43) Pub. Date: Sep. 28, 2006

(54) Method and apparatus for video stabilization

(75) Inventors: Hing Yip Chung, Hong Kong (CN); Yuk Lun Francis Chin, Hong Kong (CN); Kam Pui Chow, Hong Kong (CN); Chun Bong Leung, Hong Kong (CN); Fuk Sang Mak, Hong Kong (CN)

Correspondence Address: BUCHANAN, INGERSOLL & ROONEY PC, POST OFFICE BOX 1404, ALEXANDRIA, VA, 22313-1404, US

(73) Assignees: Multivision Intelligent Surveillance (HK) Ltd., Hong Kong (CN); The University of Hong Kong, Hong Kong (CN)

(21) Appl. No.: 11/090,638

(22) Filed: Mar. 25, 2005

(51) Int. Cl. H04N 5/228

(52) U.S. Cl. 348/208.4

(57) ABSTRACT

A method and an apparatus for video stabilization is disclosed for detecting and eliminating unwanted camera motion from a sequence of video images. Motion vectors are first generated based on sample points using a block matching technique, from which a number of possible camera motions are estimated. Among the estimated camera motions, unwanted or undesirable camera motions are then detected and parameterized. A frame remapping process is then applied to relocate the pixels in the current frame, which acts in opposition to the dislocation of pixels due to unwanted camera motions in order to achieve video stabilization.

### TECHNICAL FIELD

The present invention relates to a method and an apparatus for video stabilization, which involves the detection, estimation and removal of unwanted camera motions from the incoming video images. The method and apparatus described herein can be incorporated into both the pre-processing and post-processing stage of typical video processing system, including but not limited to video recording and playback systems.

### BACKGROUND

Video taken from a shaky camera can be quite displeasing to an audience, often causing uneasiness and nausea. Shaky motions are, however, sometimes unavoidable. For example, an outdoor highly-mounted camera will shake under windy conditions. Also, personal video cameras are abundantly available for personal use, but it is not easy for a non-professional photographer to keep a camera stable while shooting. Failure to maintain the stability of a video camera while shooting introduces unwanted motions in the recorded video, which can result in poor quality or distracting videos. Consequently, it is desirable to stabilize the incoming video images before recording takes place, or to filter out the unwanted camera motions in a recorded video. Such tasks are collectively referred as video stabilization.

Existing video stabilization techniques can be broadly classified into two main categories: optical stabilization techniques and signal processing techniques. Optical stabilization techniques stabilize the optics portion (e.g., lens/prism) of a camera by moving the optical parts in opposition to the shaking of a camera. Such techniques generally result in little or no change in the efficiency of the camera operation or the quality of the recorded image, but add significant cost to the camera and require components that are prone to mechanical wear. Moreover, such techniques work only in the video recording phase and thus are not suitable for correcting a previously-recorded video tainted by unwanted camera motions.

Signal processing techniques, on the other hand, generally involve analyzing a video signal to detect and estimate camera movements, and then transform the video signals such that the effect of unwanted camera movements are compensated. With recent advances in digital signal processing equipment and techniques, signal processing techniques, in particular those involving digital signal processing, appear to be a more economical and reliable method for video stabilization. In addition, the digital signal processing offers a feasible way of stabilizing a pro-recorded video.

Many prior works approach the problem of video stabilization from the digital signal processing perspective. However, they can suffer from a number of deficiencies. For example, they often rely heavily on the correct extraction of features such as edges, corners, etc., to identify reference area/points for camera movement estimation, meaning that some kind of sophisticated and time consuming feature extractors have to be incorporated into the video stabilization methods. Furthermore, even if reference area/points can be identified from good feature extractors, these reference area/points have to then go through another selection process to filter out some of the reference area/points that correspond to foreground objects, which usually contribute errors of the camera movement estimation. This selection process is essentially a segmentation process which segments foreground objects from the background. This, however, is not an easy task as segmentation is still a fundamental research problem that has not been fully resolved. Finally, the extracted features have to be tracked across a number of frames before the camera movement can be estimated, which further introduces inaccuracies when the tracking techniques employed are not robust enough. Related prior works can be found in U.S. Patent Application Publication No. 2003/0090593 to Xiong and in U.S. Pat. No. 5,053,876 to Blissett et al.

Some other prior works, such as those in U.S. Pat. No. 5,973,733 to Gove and U.S. Pat. No. 6,459,822 to Hathaway et al., rely on motion vectors derived from block matching techniques for the camera motion analysis. These prior works generally partition a video frame into non-overlapping blocks, and all of these blocks must be involved in the motion estimation process. Motion vectors obtained under this approach are reasonably good in representing the true motions in a scene under the assumption that the motion discontinuities only occur at the regularly spaced block boundaries. However, this assumption is not likely to hold for typical operational environment. Moreover, since all the blocks must be involved in the motion estimation process, it does not offer a flexible way to scale computation requirement up or down to meet different computation constraints.

Additional references that include camera motion estimation methods, but are not particularly focused on video stabilization, include U.S. Pat. No. 6,710,844 to Han et al., U.S. Pat. No. 5,742,710 to Hsu et al., U.S. Pat. No. 6,349,114 to Mory, U.S. Pat. No. 6,738,099 to Osberger, U.S. Pat. No. 5,751,838 to Cox et al., U.S. Pat. No. 6,707,854 to Bonnet et al., and U.S. Pat. No. 5,259,040 to Hanna. Methods described in these references, however, suffer the same aforementioned problems.

What is desired is a robust and efficient video stabilization method that neither depends on feature extraction and segmentation, nor relies on an assumption that cannot reliably hold under normal operating conditions.

### SUMMARY

Disclosed herein is a method and apparatus for providing computationally efficient and robust video stabilization that favors both software and hardware implementation.

According to the present disclosure, a set of sample blocks can be derived from a set of sample points, for example where each sample block is centered about the associated sample point. Motion vectors for these blocks can then be generated by a block matching technique using a current frame and a reference frame. These sample block motion vectors, representing the motion of the associated sample points, can then be used for camera motion estimation.

The camera motion can be estimated based on a valid subset of motion vectors according to the affine camera motion model. A subset can be considered valid if the associated sample blocks are not collinear. By considering different combinations of subsets of non-collinear blocks out of the set of sample blocks, a set of possible camera motion parameters can thus be obtained.

The final camera motion can be obtained by searching over a space of possible camera motion parameters. By evaluating the likelihood of the existence of unwanted motion for each possible motion parameter according to a similarity measurement, a final estimated camera motion can be selected as a motion parameter that results in a best similarity measurement. The best similarity measurement is then compared against a threshold to determine whether the final motion parameter actually represents an unwanted camera motion.

The final motion parameter can be used to remap the current frame to generate an output frame in order to eliminate the detected unwanted camera motion, thus resulting in stabilized video.

### BRIEF DESCRIPTION OF THE DRAWINGS

Embodiments are illustrated by way of example in the accompanying figures, in which like reference numbers indicate similar parts, and in which:

FIG. 1 shows a block diagram of a video stabilization apparatus;

FIG. 2 shows a more detailed block diagram of the video stabilization apparatus shown in FIG. 1;

FIGS. 3A-3E show different combinations of three blocks out of an exemplary set of four sample points; and

FIG. 4 shows examples of types of camera motions that can be stabilized using a system such as that shown in FIG. 1.

### DETAILED DESCRIPTION

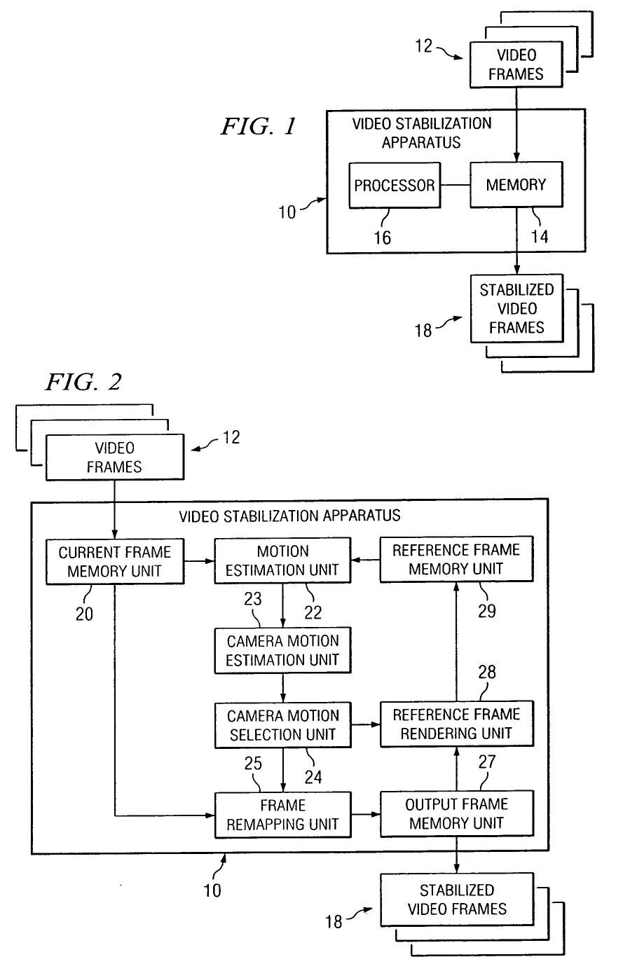

FIG. 1 shows a block diagram of a video stabilization apparatus 10. Such a video stabilization apparatus 10 can be a stand-alone device or can be integrated into another device, for example a video recording device, a video processing device, a video playback device, or a computer. Digitized video frames 12 are passed in succession to a memory 14. The memory 14 is in communication with a processor 16 for performing video stabilization processes as described below. Stabilized video frames 18 are successively output from the memory 14.

FIG. 2 shows a more detailed block diagram of the video stabilization unit 10. As shown in FIG. 2, the video stabilization unit 10 includes various memory units, including a current frame memory 20, a reference frame memory unit 29, and an output frame memory unit 27, which are collectively shown as the memory 14 in FIG. 1. The memory units 20, 27, and 29 can thus be implemented in a single memory device as shown in FIG. 1 and/or in separate memory devices as shown in FIG. 2. The video stabilization unit 10 also includes various processing units, including a motion estimation unit 22, a camera motion estimation unit 23, a camera motion selection unit 24, a frame remapping unit 25, and a reference frame rendering unit 28, which are collectively shown as the processor 16. Thus, in the embodiment shown in FIG. 1, the processor 16 is software-controlled to perform the various functions of the units 22-25 and 28 shown in FIG. 2. FIG. 2 can be considered to also be representative of an alternative embodiment where the units 22-25 and 28 are processing circuits.

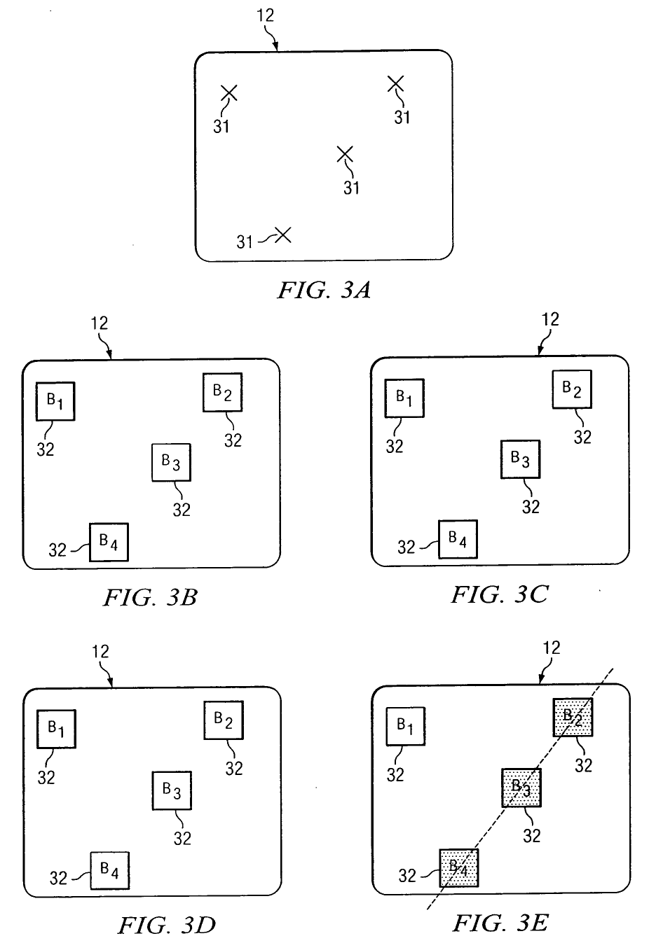

The current frame memory unit 20 is for receiving and storing the input video frames 12 as they are successively input to the video stabilization apparatus 10. At any instant, a video frame 12 stored in the memory unit 20 can be considered a current video frame, whereas a video frame stored in the memory unit 29, for example a previously stabilized video frame, can be considered a reference video frame. The current and reference video frames are provided to a motion estimation unit 22, where they can be used for deriving motion vectors based on set of sample points 31 (shown in FIG. 3A). A process for determining the motion vectors is described below.

Referring now also to FIGS. 3A-3E, the motion estimation unit 22 first constructs a set of sample blocks 32 from the set of sample points 31. Locations of the sample points 31 can be pre-defined or randomly selected. Let B(m, n) denote a sample block 32 centered about a sample point 31 at the m^{th} column and n^{th} row in a current frame, for example where a frame is composed of columns and rows of pixel data. Consider a set of N sample blocks 32 {B₁, B₂, . . . , B_{N}} where Bᵢ=B(mᵢ, nⱼ), the motion estimation unit 22 uses the current and reference video frames to determine a motion vector Vᵢ for each block Bᵢ using any existing block-matching motion estimation technique. Note that in each frame the set of sample points 31 can be altered to adapt to the changes in scene composition or operational environment. The number of sample points 31 can also be changed to satisfy different computation requirements.

After the motion vectors of the set of sample blocks 32 are obtained, these motion vectors are then provided to a camera motion estimation unit 23. The camera motion estimation unit 23 estimates the camera motion for combinations of valid subsets of the set of N motion vectors, a subset being valid under a condition that the associated sample points are not collinear. For example, consider a scenario where there are only four sample points 31 as depicted in FIG. 3A, and the size of the subsets is set such that each subset includes three sample blocks 32. FIGS. 3B to 3D show the valid subsets of sample blocks 32 for camera motion estimation, in which the three shaded sample blocks 32 under consideration are not collinear. FIG. 3E shows an invalid subset of sample blocks 32 for camera motion estimation, in which the three shaded blocks under consideration are collinear. The reason for this restriction is given below, after the camera motion estimation method is detailed.

The camera motion estimation unit 23 can estimate the camera motion, for example according to the six parameter affine motion model. Denoting the coordinate of the pixel at the m^{th} column and the n^{th} row as [m, n, 1]^{T}, and assuming all pixel movements are due to camera motion, then, for any pixel at coordinate [mᵢ, nᵢ, 1]^{T} in the current frame, the pixel coordinate [m′ᵢ, n′ᵢ, 1]^{T} of the corresponding pixel in the reference frame is as follows:

$$[ \begin{matrix}{m}_{i}^{′} \\ {n}_{i}^{′} \\ 1\end{matrix} ] = [ \begin{matrix}{am}_{i} + {bn}_{i} + c \\ d {m}_{i} + {en}_{i} + f \\ 1\end{matrix} ] = [ \begin{matrix}a & b & c \\ d & e & f \\ 0 & 0 & 1\end{matrix} ] [ \begin{matrix}{m}_{i} \\ {n}_{i} \\ 1\end{matrix} ] \qquad ( 1 )$$

Suppose there are three sample blocks 32 Bᵢ, Bⱼ and Bₖ centered about the sampling points with coordinates [mᵢ, nᵢ, 1]^{T}, [mⱼ, nⱼ, 1]^{T} and [mₖ, nₖ, 1]^{T} respectively, whose corresponding motion vectors are Vᵢ=[pᵢ, qᵢ, 0]^{T}, Vⱼ=[pⱼ, qⱼ, 0]^{T} and Vₖ=[pₖ, qₖ, 0]^{T}. The corresponding locations of these blocks in the reference frame are then [mᵢ+p₁, nᵢ+qᵢ, 0]^{T}, [mⱼ+pⱼ, nⱼ+qᵢ, 0]^{T}, [mₖ+pₖ, nₖ+qₖ, 0]^{T}. If the assumption that the motion vectors represent the true motion of the sample points 31 holds, then:

$$[ \begin{matrix}{m}_{i} + {p}_{i} & {m}_{j} + {p}_{j} & {m}_{k} + {p}_{k} \\ {n}_{i} + {q}_{i} & {n}_{j} + {q}_{j} & {n}_{k} + {q}_{k} \\ 1 & 1 & 1\end{matrix} ] = [ \begin{matrix}{m}_{i}^{′} & {m}_{i}^{′} & {m}_{k}^{′} \\ {n}_{i}^{′} & {n}_{i}^{′} & {n}_{k}^{′} \\ 1 & 1 & 1\end{matrix} ] = [ \begin{matrix}a & b & c \\ d & e & f \\ 0 & 0 & 1\end{matrix} ] [ \begin{matrix}{m}_{i} & {m}_{j} & {m}_{k} \\ {n}_{i} & {n}_{j} & {n}_{k} \\ 1 & 1 & 1\end{matrix} ] \qquad ( 2 )$$

After some matrix manipulations, it yields:

$$[ \begin{matrix}{p}_{i} & {p}_{j} & {p}_{k} \\ {q}_{i} & {q}_{j} & {q}_{k} \\ 0 & 0 & 0\end{matrix} ] = [ \begin{matrix}a - 1 & b & c \\ d & e - 1 & f \\ 0 & 0 & 0\end{matrix} ] [ \begin{matrix}{m}_{i} & {m}_{j} & {m}_{k} \\ {n}_{i} & {n}_{j} & {n}_{k} \\ 1 & 1 & 1\end{matrix} ] \qquad ( 3 )$$

Now, provided that the three sample blocks, Bᵢ, Bⱼ, and Bₖ are not collinear with each other, then, the affine motion transformation matrix A can be derived as follows:

$$A = [ \begin{matrix}a & b & c \\ d & e & f \\ 0 & 0 & 1\end{matrix} ] = {[ \begin{matrix}{p}_{i} & {p}_{j} & {p}_{k} \\ {q}_{i} & {q}_{j} & {q}_{k} \\ 0 & 0 & 0\end{matrix} ] [ \begin{matrix}{m}_{i} & {m}_{j} & {m}_{k} \\ {n}_{i} & {n}_{j} & {n}_{k} \\ 1 & 1 & 1\end{matrix} ]}^{- 1} + [ \begin{matrix}1 & 0 & 0 \\ 0 & 1 & 0 \\ 0 & 0 & 1\end{matrix} ] \qquad ( 4 )$$

From Equation (4), it can be seen that the camera motion, parameterized in the form of a transformation matrix, can be estimated from the motion vectors, provided that the three sample blocks 32 in consideration are not collinear. By using Equation (4), the camera motion estimation unit 23 can estimate a number of possible camera motion parameters by considering different subsets of the N non-collinear sample blocks 32.

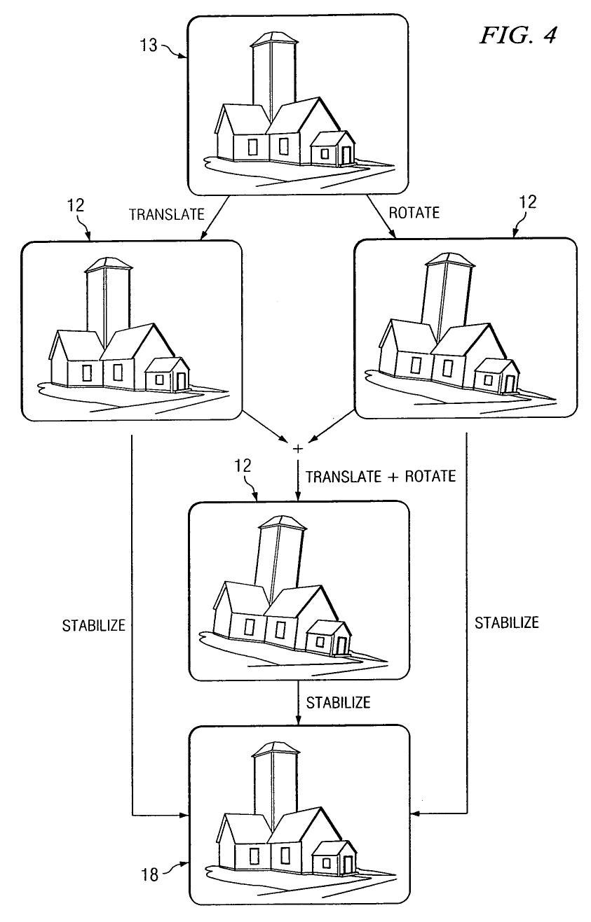

FIG. 4 shows some typical unwanted camera motions, by which an input video frame 12 of a scene 13 is tainted. The affine camera motion model described in this invention can handle all, but not limited to, these typical motions.

Referring again to FIG. 2, after the camera motion estimation unit 23 completes the camera motion estimation process, all of the camera motion parameters calculated by the camera motion estimation unit 23 are provided to the camera motion selection unit 24. The camera motion selection unit 24 evaluates each of the received camera motion parameters to see if any represent unwanted camera motion. One method of evaluating a camera motion parameter is to remap the pixel coordinate of each pixel in the current image, according to Equation (1) using the camera motion parameter under consideration, to a new coordinate according to the camera motion parameter, and relocate the pixel to that remapped coordinate accordingly to construct a remapped image. If the remapped image is similar to the reference image, it is reasonable to assume that estimated camera motion is accurate. To evaluate the similarity between the remapped and reference frame, the majority area of the remapped image can be compared with that in the reference image according to some similarity measurements. Examples of such similarity measurements that can be used include frame difference, sum of squared differences. The camera motion parameter that yields the most desirable similarity measurement can be chosen as the final camera motion parameter.

On the other hand, rather than constructing a complete remapped image, it is also possible to remap only a subset of pixel coordinates of the pixels in the current image to form a partially remapped image, such that only these remapped pixels contribute to the similarity measurement for selecting the best camera motion parameter. The camera motion selection unit 24 can also reject all of the received camera motion parameters if the best similarity measurement indicates no camera motion appears to be unwanted or undesirable motion. Under this situation, the camera motion selection unit 24 should return an affine transformation that has no effect in the subsequent frame remapping process, for example:

$$A = [ \begin{matrix}1 & 0 & 0 \\ 0 & 1 & 0 \\ 0 & 0 & 1\end{matrix} ]$$

The frame remapping unit 25 will then receive the final camera motion parameter from camera motion selection unit 24. In essence, the frame remapping unit 25 takes the final camera motion parameter and employs Equation (1) to remap all the pixel coordinates in the current frame to another set of pixel coordinates. Each pixel will then be relocated to its remapped coordinate accordingly to form the remapped output frame. It should be noted that the pixel coordinates remapping process can also be done on a sub-pixel basis to improve stabilization performance, provided that appropriate interpolation methods are used for the relocation of the pixel at sub-pixel accuracy. The remapped output frame will then be stored in the output frame memory unit 27 to serve as the stabilized video frame 18.

The reference frame rendering unit 28 reads the stabilized video frame from the output frame memory unit 27 and prepares a reference frame for a next iteration of the stabilization process. The reference frame rendering unit 28 can update the reference frame memory unit 29 by cloning the content in output frame memory unit 27 at each iteration, or it can do so periodically at a pre-defined sampling frequency. Another method of preparing the reference frame is to consider the similarity measurement taken from camera motion selection unit 24 and determine whether the estimated camera motion attains a certain predetermined level of confidence. If the confidence is higher than the pre-defined threshold, then the reference frame rendering unit 28 updates the reference frame. Otherwise, a previously-prepared reference frame can be retained in the reference frame memory unit 29 for the next iteration.

The process described above can be repeated for the each incoming video frame 12. Referring again to FIG. 4, after the above process for stabilization, the stabilized video frames 18, with unwanted motions removed, can be obtained.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A video stabilization apparatus comprising:
memory for storing current frame data representative of a current frame and reference frame data representative of a reference frame; and
one or more processors connected to the memory and operable (a) to retrieve the current frame data and the reference frame data; (b) to calculate motion vectors based on the current frame data and the reference frame data; (c) to estimate a set of motion parameters based on the motion vectors; (d) to select a final motion parameter from the set of motion parameters, and (e) to generate, based on the final motion parameter, output frame data representative of an output frame.

2. A video stabilization apparatus according to claim 1, wherein the one or more processors comprises a single processor for calculating the motion vectors, estimating the set of motion parameters, selecting the final motion parameter, and generating the output frame data based on the final motion parameter.

3. A video stabilization apparatus according to claim 1, wherein the one or more processors comprises a plurality of processing units, wherein each of the processing units is operable to perform at least one of calculating the motion vectors, estimating the set of motion parameters, selecting the final motion parameter, and generating the output frame data.

4. A video stabilization apparatus according to claim 1, wherein the calculating of the motion vectors is based on a set of sample points at predefined positions in the current frame.

5. A video stabilization apparatus according to claim 1, wherein the calculating of the motion vectors is based on a set of sample points at randomly selected positions in the current frame.

6. A video stabilization apparatus according to claim 1, wherein the generating of the output frame data includes remapping pixel coordinates of the current frame data to new coordinates based on the final motion parameter.

7. A video stabilization apparatus according to claim 1, wherein the one or more processors is further for rendering reference frame data based on the output frame data.

8. A video stabilization apparatus according to claim 1, wherein the calculating of the motion vectors is based on a set of sample points in the current frame.

9. A video stabilization apparatus according to claim 8, wherein the calculating of the motion vectors includes:
constructing, for each sample point, a sample block of pixels that includes the sample point; and
performing block matching motion estimation using the current frame data and the reference frame data to obtain the motion vectors.

10. A video stabilization apparatus according to claim 8, wherein the set of motion vectors includes a plurality of sample-point subsets, and wherein the estimating of the set of motion parameters includes checking sample-point subsets to determine whether they are valid sample-point subsets, and calculating the motion parameters based on the valid sample-point subsets.

11. A video stabilization apparatus according to claim 10, wherein a sample-point subset is considered valid if the sample points of the sample-point subset are non-collinear.

12. A method of video stabilization comprising:
storing current frame data representative of a current frame and reference frame data representative of a reference frame;
calculating motion vectors based on the current frame data and the reference frame data;
estimating a set of motion parameters based on the motion vectors;
selecting a final motion parameter from the set of motion parameters; and
generating, based on the final motion parameter, output frame data representative of an output frame.

13. A method of video stabilization according to claim 12, wherein the calculating of the motion vectors is based on a set of sample points at predefined positions in the current frame.

14. A method of video stabilization according to claim 12, wherein the calculating of the motion vectors is based on a set of sample points at randomly selected positions in the current frame.

15. A method of video stabilization according to claim 12, wherein the generating of the output frame data includes remapping pixel coordinates of the current frame data to new coordinates based on the final motion parameter.

16. A method of video stabilization according to claim 12, further comprising rendering reference frame data based on the output frame data.

17. A method of video stabilization according to claim 12, wherein the calculating of the motion vectors is based on a set of sample points in the current frame.

18. A method of video stabilization according to claim 17, wherein the calculating of the motion vectors includes:
constructing, for each sample point, a sample block of pixels that includes the sample point; and
performing block matching motion estimation using the current frame data and the reference frame data to obtain the motion vectors.

19. A method of video stabilization according to claim 17, wherein the set of motion vectors includes a plurality of sample-point subsets, and wherein the estimating of the set of motion parameters includes checking sample-point subsets to determine whether they are valid sample-point subsets, and calculating the motion parameters based on the valid sample-point subsets.

20. A method of video stabilization according to claim 19, wherein a sample-point subset is considered valid if the sample points of the sample-point subset are non collinear.

21. A method of camera motion estimation comprising:
selecting a subset of sample points from a set of sample points, the subset including at least three non-collinear sample points;
calculating motion parameters based on the selected subset of sample points and motion vectors associated with the selected subset of sample points; and
repeating the selection of the sample points and the calculating of the motion parameters, thereby obtaining a set of camera motion parameters, for no more than a pre-defined number of iterations.

22. A method of camera motion estimation according to claim 21, wherein the repeating is performed for less than the predefined number of iteration if all possible subsets have been exhausted.

23. A method of camera motion estimation according to claim 21, wherein the calculating of motion parameters includes calculating affine motion parameters.

24. A method comprising:
forming a plurality of at least partially remapped video frames, including forming different ones of the plurality of remapped video frames based on different ones of a plurality of camera motion parameters;
determining respective degrees of similarity between the remapped video frames and a reference frame;
selecting as a final camera motion parameter the camera motion parameter associated with the remapped video frame that a highest degree of similarity to the reference frame; and
if the highest degree of similarity obtained during the determining is indicative of an estimated camera motion that does not appear to include unwanted or undesirable motions, setting the final camera motion parameter to have no effect on a frame remapping process.

25. A method of video stabilization comprising:
storing current frame data representative of a current frame and reference frame data representative of a reference frame;
calculating a motion parameter based on the current frame data and the reference frame data;
generating, based on the motion parameter, output frame data representative of an output frame;
determining a degree of similarity between the output frame and the reference frame; and
generating a new reference frame using the output frame data if the degree of similarity is above a predetermined threshold.

26. A method of video stabilization according to claim 25, wherein the determining of the degree of similarity includes sampling data of the output frame for each iteration of the generating of the output frame.

27. A method of video stabilization according to claim 25, wherein the determining of the degree of similarity includes sampling data of the output frame at fixed intervals of the generating of the output frame.
